(19) United States
(12) Patent Application Publication
(10) Pub. No.: US 2023/0039798 A1
(43) Pub. Date: Feb. 9, 2023

(54) DOOR SYSTEM FOR A PUBLIC TRANSPORT VEHICLE

(71) Applicant: Bode - Die Tür GmbH, Kassel (DE)

(72) Inventors: Christoph THEIS, Bad Wildungen (DE); Sebastian THOR, Leinefelde (DE)

(21) Appl. No.: 17/879,321

(22) Filed: Aug. 2, 2022

(30) Foreign Application Priority Data
Aug. 4, 2021 (DE) 20 2021 104 171.4

(51) Int. Cl. E05D 15/10; E05F 15/646

(52) U.S. Cl. CPC E05D 15/1068; E05F 15/646; E05Y 2900/51; E05Y 2201/624; E05Y 2800/12

(57) ABSTRACT

A door system has a door leaf configured to be moved between closed and opened positions while carrying out a door leaf movement. The door leaf is moved in the vehicle transverse direction across a door leaf movement distance in the vehicle transverse direction, a door seal, disposed underneath a lower edge of the door leaf closing off the door leaf towards the bottom, and extends along the lower edge. The door seal is arranged such that the door seal, when the door leaf movement is carried out, undergoes a door seal movement and is moved in the process in the vehicle transverse direction across a door seal movement distance in the vehicle transverse direction. An arrangement of the door leaf and door seal that ensures that the door seal movement distance in the vehicle transverse direction is smaller than the door leaf movement distance in the vehicle transverse direction.

### CROSS REFERENCE TO RELATED APPLICATIONS

This application is related to and claims the benefit of German Patent Application No. 20 2021 104 171.4, filed on Aug. 4, 2021, the contents of which are herein incorporated by reference in their entirety.

### TECHNICAL FIELD

The present disclosure relates to a door system, in particular a pivot sliding door system, for a public transport vehicle, comprising a door leaf, which can be moved from a closed position towards an opened position and vice versa while carrying out a door leaf movement, wherein the door leaf, when carrying out the door leaf movement, is moved in the vehicle transverse direction across a door leaf movement distance in the vehicle transverse direction. The door system further comprises a door seal, which is disposed underneath a lower edge of the door leaf closing off the door leaf towards the bottom, and extends along the lower edge.

The present disclosure may relate to both road vehicles and rail vehicles (within the nomenclature of the present disclosure, both are to be understood to be “vehicles”). Even a use in vehicles of other vehicle categories, e.g. in aircraft or watercraft, is conceivable. A road vehicle is to be understood to be, in particular, a wheeled vehicle, e.g. a public transport vehicle such as a bus. A rail vehicle is also to be understood to denote public transport vehicles, such as trains, streetcars, trams, underground trains, urban-suburban commuter railway trains (S-Bahn), commuter trains, long-distance trains, regional trains or the like. Rail vehicles travel on rails.

### BACKGROUND

Door systems for public transport vehicles have door portals via which passengers may enter the vehicle and exit it (boarding). Door systems, which—depending on their design—may include one or two door leaves (single-leaf door system, double-leaf door system), are assigned to such door portals. Generally, such a door leaf is supported in such a way that it can be moved between a closed position (in which it blocks the door portal) and an opened position (in which it clears the door portal for boarding). In a situation of a vehicle stopping in the immediate vicinity of a platform (e.g. a train platform), the platform and the external vehicle shell are generally separated by a gap. When boarding, this gap (and frequently also a difference in height) has to be negotiated by the passengers. Depending on the position of the vehicle relative to the platform, there may thus be a height difference between the floor level of a floor in the vehicle interior and a ground surface of the platform. In such a case, the distance in the height level of the floor and the ground surface of the platform is insufficient for preventing a lower door seal from dragging over the platform. Hereinafter, this issue—which was recognized by the inventors—will be specifically described within the context of tram vehicles (but is also transferable to other vehicles).

In tram vehicles, such door seals are often used in the form of externally situated seals or reasons of cost. In this case, the vehicle body with the tread strip (door sill) serves as a sealing surface, and no separate sealing brackets are installed in the vehicle. In certain situations of the vehicle stopping at a platform, a lower door seal (a door seal disposed underneath the door leaf) of pivot sliding doors opening towards the outside, for example, may—due to an insufficient distance between the vehicle and the platform—contact the platform during opening and drag over it or be damaged.

In the case of a small distance between the vehicle and the platform, the door leaf is generally positioned at a sufficient height above the platform. In order to enable people with limited mobility, for example, to board the vehicle from the platform as easily as possible, the height of the step between the tread strip and the platform is supposed to be as small as possible. In certain stopping situations, the platform may even be situated above the tread strip. The tread strip in the vehicle is precisely defined with regard to its position (standard specifications) and thus also determines the position of the lower door seal because the door system seals against the tread strip.

During the opening process, the door leaf first carries out an outward pivoting movement, which may result in a collision of the lower door seal with the platform. This limits the opening process or may result in great wear on the seal.

### SUMMARY

Thus, the present disclosure is based on providing a door system in which damage/wear of a door seal sealing the door system at a lower edge of a door leaf when opening/closing the door leaf is prevented.

A door system with the features of claim 1 is proposed in order to achieve the object.

It must be noted that the features cited individually in the claims can be combined with each other in any technologically meaningful manner (even across the boundaries of categories) and represent other embodiments of the disclosure. The description, in particular in connection with the figures, additionally characterizes and specifies the disclosure.

It may also be noted that a conjunction “and/or” used hereinafter, which is situated between two features and links them to each other, should always be interpreted such that, in a first embodiment of the subject matter according to the disclosure, only the first feature may be provided, in a second embodiment of the subject matter according to the disclosure, only the second feature may be provided, and in a third embodiment of the subject matter according to the disclosure, both the first and the second feature may be provided.

First, the present disclosure relates to a door system, in particular a pivot sliding door system, for a public transport vehicle, comprising
a. a door leaf, which can be moved from a closed position towards an opened position and vice versa while carrying out a door leaf movement, wherein the door leaf, when carrying out the door leaf movement, is moved in the vehicle transverse direction across a door leaf movement distance in the vehicle transverse direction;
b. a door seal, which is disposed underneath a lower edge of the door leaf closing off the door leaf towards the bottom, and extends along the lower edge, wherein the door seal is arranged such that the door seal, when the door leaf movement is carried out, undergoes a door seal movement and is moved in the process in the vehicle transverse direction across a door seal movement distance in the vehicle transverse direction.

A door system according to the disclosure is characterized by such an arrangement of the door leaf and the door seal that ensures that the door seal movement distance in the vehicle transverse direction is smaller than the door leaf movement distance in the vehicle transverse direction. For this purpose, the door seal may be actively movable and, for example, be movably supported on a sliding fit member. In order to prevent the above-mentioned contact between the door seal and the platform, it is provided that the door seal pivots outwards to a lesser extent than the door leaf (door seal movement distance in the vehicle transverse direction smaller than the door leaf movement distance in the vehicle transverse direction).

Further configurations of the door system proposed by the disclosure are described hereinafter. The following description includes those configuration features specified in the dependent claims but is not limited thereto. Express mention is made of the fact that the features described below with respect to the door system proposed by the disclosure may readily also be configuration features of the door system proposed by the disclosure.

According to a first configuration of a door system proposed by the disclosure, it may be provided that the door seal comprises a sealing lip. The sealing lip is preferably made from a sealing material, which at least partially has elastic properties. For example, the sealing lip may be made from a rubber material.

According to another configuration of a door system proposed by the disclosure, it may be provided that the door leaf is connected via a door leaf connecting means, and the door seal via a door seal connecting means, with a rotary device associated with the door system, particularly a rotary column. Compared with known door systems—which are in part sold by the applicant—an additional pivot arm, which is assigned to the door seal, is provided in the door system according to the disclosure in addition to the lower pivot arm (which is attached to the door leaf). This pivot arm may also (but does not have to) be connected to a rotary column of the door system. It may also be arranged on a separate rotary device or connected therewith.

According to another configuration of a door system proposed by the disclosure, it may be provided that the door leaf connecting means and the door seal connecting means are configured in the shape of pivot arms, wherein, in each case, one first pivot arm end of the respective connecting means is connected to the rotary device, in particular the rotary column, and wherein at least one guide means, in particular a guide roller, which is guided in a guiding profile respectively disposed on the door leaf and the door seal, is disposed in each case on a second pivot arm end of the respective connecting means opposite the first pivot arm end.

According to another configuration of a door system proposed by the disclosure, it may be provided that the door seal connecting means has a first lever arm, and that the door leaf connecting means has a second lever arm, wherein the first lever arm is smaller than the second lever arm. This may provide the basis for the difference between the door seal movement distance in the vehicle transverse direction and the door leaf movement distance in the vehicle transverse direction.

According to another configuration of a door system proposed by the disclosure, it may be provided that the door leaf is connected via a door leaf connecting means, and the door seal via a door seal connecting means, in each case with separate rotary devices, wherein separate drive units are assigned to the respective rotary devices.

According to another configuration of a door system proposed by the disclosure, a control unit may be provided, which is connected in a controlling manner with the rotary devices and is configured to recognize whether the door seal, during the opening of the door leaf, was moved across a predetermined door seal movement distance in the vehicle transverse direction, and is further configured, in the case of a movement of the door seal across the predetermined door seal movement distance in the vehicle transverse direction, to block further movement of the door seal during the opening of the door leaf. For this purpose, the control unit may be equipped with suitable measuring and evaluating means. The control unit may also be provided with a drive unit providing for the movement of the door seal, and the recognition may take place based on drive unit data.

In addition to the door system, the disclosure may also relate to a door seal for a door system according to the disclosure.

### BRIEF DESCRIPTION OF THE DRAWINGS

The disclosure is further explained with reference to the following Figures. They are to be understood as mere examples and are not intended to limit the disclosure to the exemplary embodiments shown.

In the Figures:

FIG. 1 shows a schematic illustration of a section, in a perspective view, of a door system for a vehicle known from the prior art, wherein the vehicle is in a situation of stopping at a platform, wherein the door system comprises a door leaf and a door seal;

FIG. 2 shows a schematic side view of a door system according to FIG. 1 in a position in which the door leaf is closed;

FIG. 3 shows a schematic side view of a door system according to FIGS. 1 and 2 in a position in which the door leaf is opened and the door seal drags across the platform;

FIG. 4 shows a schematic side view of a door system according to the disclosure with an actively displaceable door seal for avoiding a sliding contact of the door seal with the platform;

FIG. 5 shows a schematic perspective view of a lower section of the inventive door system according to a first exemplary embodiment in a closed position of the door leaf;

FIG. 6 shows a schematic perspective view of a lower section of the inventive door system according to FIG. 5 in an opened position of the door leaf;

FIG. 7 shows a schematic side view of a lower section of the inventive door system according to the first embodiment in the position according to FIG. 5; and

FIG. 8 shows a schematic side view of a lower section of the inventive door system according to the first embodiment in the position according to FIG. 6.

### DETAILED DESCRIPTION OF THE DRAWINGS

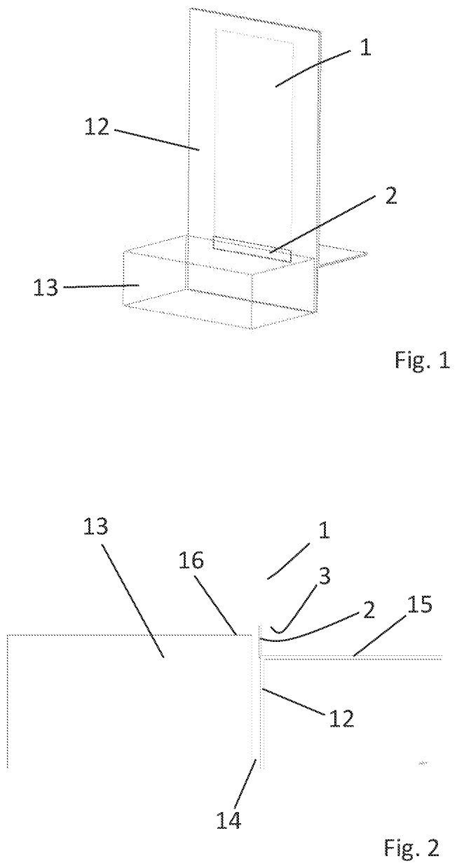

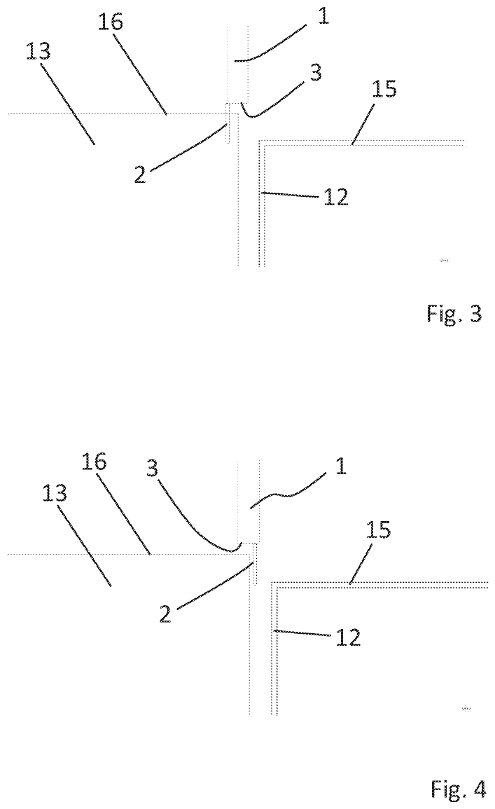

Door systems for public transport vehicles have door portals via which passengers may enter the vehicle and exit it (boarding). Door systems, which—depending on their design—may include one or two door leaves 1, are assigned to such door portals. Such a door leaf 1 is supported in such a way that it can be moved between a closed position (in which it blocks the door portal) and an opened position (in which it clears the door portal for boarding). The movement is realized by means of a suitable drive unit, which may be arranged above the door leaf 1, for example. The door leaf 1 may be suspended in a suitable supporting device. FIG. 1 shows, by way of example (and schematically), a door leaf 1 in a closed position. The door leaf 1 is surrounded by an external vehicle shell 12 (or vehicle paneling). FIG. 1 illustrates a situation of the vehicle stopping, i.e. the door leaf 1 is positioned in the direct vicinity of a platform 13 (e.g. a train platform). The platform 13 and the external vehicle shell 12—when the vehicle stops—are generally separated by a gap 14. When boarding, this gap 14 has to be negotiated by the passengers. Depending on the position of the vehicle relative to the platform 13, there may thus be a height difference between the floor level of a floor 15 in the vehicle interior and a ground surface 16 of the platform 13 (FIG. 2). In such a case—which is known from the prior art—the distance in the height level of the floor 15 and the ground surface 16 of the platform 13 is insufficient for preventing the door seal 2 from dragging over the platform 13. As a consequence of such a dragging/such a contact (see FIG. 3), the lower door seal 2 may be damaged or wear down. Accordingly, it is provided according to the disclosure that the door seal 2, when the door leaf 1 is opened, pivots outwards to a lesser extent than the door leaf 1. Thus, the door seal 2 is decoupled from the movement of the door leaf 1 to a certain extent. For this purpose, it is provided that the door seal 2 can be actively moved. In this case, the door seal 2 may be supported on a sliding fit member and moved in the vehicle transverse direction Q, see the position of the door seal 2 in FIG. 4 compared to the position in FIG. 3 (without active displacement of the door seal 2). Thus, there may be a relative movement between the door seal 2 and the door leaf 1.

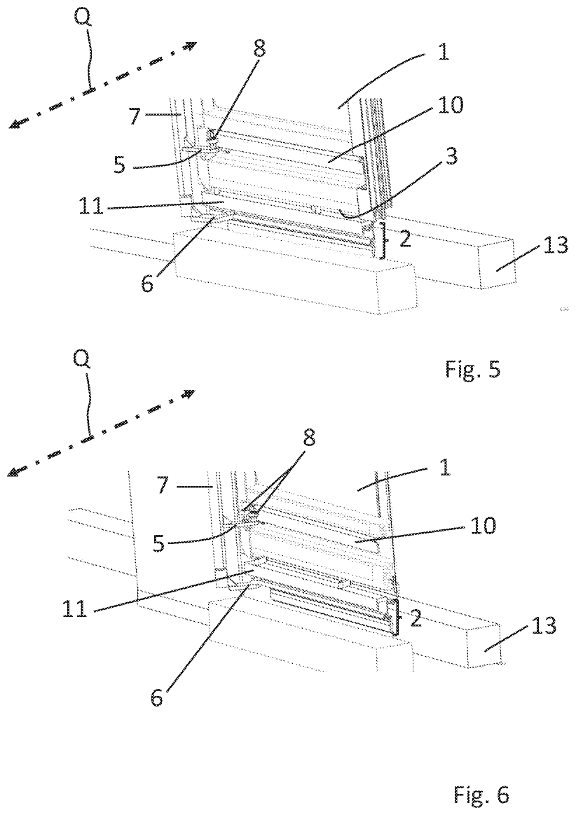

The basic structure of the door system according to the disclosure is shown in FIGS. 5 and 6, which present a lower section of the door system in a perspective view both in a closed position of the door leaf 1 (FIG. 5) and in an opened position of the door leaf 1 (FIG. 6).

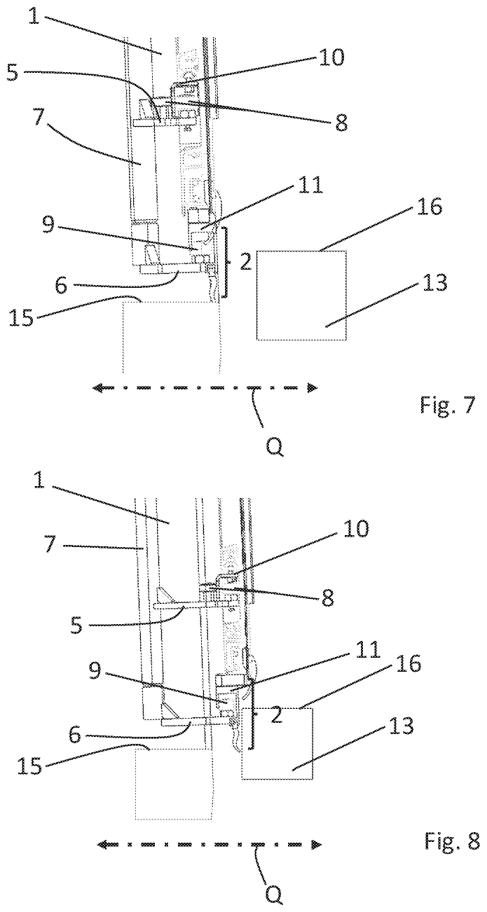

Preferably, but not necessarily, the door system is a pivot sliding door system for a public transport vehicle. The door system comprises a door leaf 1, which can be moved from a closed position (FIGS. 5, 7) towards an opened position (FIGS. 6, 8) and vice versa while carrying out a door leaf movement. In the case of a pivot sliding door system, the door leaf movement is a superposed pivot sliding movement. The door leaf 1, when carrying out the door leaf movement, is moved in the vehicle transverse direction Q across a door leaf movement distance in the vehicle transverse direction, see the position of the door leaf 1 in FIGS. 7 (closed position) and 8 (opened position). In a pivot sliding door system, the door leaf 1, in addition to the movement along the vehicle transverse direction Q, also carries out a measure of a pivoting movement (not shown) when carrying out the door leaf movement. The door system may be a single-leaf door system (one door leaf 1) or a double-leaf door system (two door leaves 1).

In addition, the door system comprises a door seal 2, which is disposed underneath a lower edge 3 of the door leaf 1 closing off the door leaf towards the bottom, and extends along the lower edge 3, wherein the door seal 2 is arranged such that the door seal 2, when the door leaf movement is carried out, undergoes a door seal movement and is moved in the process in the vehicle transverse direction Q across a door seal movement distance in the vehicle transverse direction. The door seal movement is apparent from a comparison of FIGS. 7 (closed position of the door leaf 1) and 8 (opened position of the door leaf 1), for example. The door seal 2 has a sealing lip 4. The door leaf 1 and the door seal 2 are arranged in such a manner that it is ensured that the door seal movement distance in the vehicle transverse direction is smaller than the door leaf movement distance in the vehicle transverse direction, whereby the door seal 2 is prevented from dragging across the platform 13.

In the exemplary embodiment shown in FIGS. 5 to 8, the door leaf 1 is connected via a door leaf connecting means 5, and the door seal 2 via a door seal connecting means 6, with a rotary device associated with the door system, which may be configured in the form of a rotary column 7, for example. The door leaf connecting means 5 and the door seal connecting means 6 are configured in the form of pivot arms. As is shown in FIGS. 5 to 8, one first pivot arm end of the respective connecting means 5, 6 is in each case connected to the rotary column 7. At least one guide means, in particular a guide roller 8, 9, which is guided in a guiding profile 10, 11 respectively disposed on the door leaf 1 and the door seal 2, is disposed in each case on a second pivot arm end of the respective connecting means 5, 6 opposite the first pivot arm end. A plurality of guide rollers 8 is disposed on the door leaf connecting means 5; in particular, three guide rollers 8 may be provided, wherein it is not necessary that all of the three guide rollers 8 are guided within the guiding profile 10, but may also roll along a surface (e.g. an outer surface) of the guiding profile 10. The door seal connecting means 6 has a first lever arm, while the door leaf connecting means 5 has a second lever arm. The first lever arm is smaller than the second lever arm. The different lever arms ensure that the door seal movement distance in the vehicle transverse direction is smaller than the door leaf movement distance in the vehicle transverse direction, so that the door seal 2 is prevented from dragging across the ground surface 16 of the platform 13.

1. A door system, in particular a pivot sliding door system, for a public transport vehicle, comprising:
a. a door leaf, configured to be moved from a closed position towards an opened position and from the closed position to the opened position while carrying out a door leaf movement, wherein the door leaf, when carrying out the door leaf movement, is moved in the vehicle transverse direction across a door leaf movement distance in the vehicle transverse direction;
b. a door seal, which is disposed underneath a lower edge of the door leaf closing off the door leaf towards the bottom, and extends along the lower edge, wherein the door seal is arranged such that the door seal, when the door leaf movement is carried out, undergoes a door seal movement and is moved in the process in the vehicle transverse direction across a door seal movement distance in the vehicle transverse direction;
wherein such an arrangement of the door leaf and the door seal that ensures that the door seal movement distance in the vehicle transverse direction is smaller than the door leaf movement distance in the vehicle transverse direction.

2. The door system according to claim 1, wherein that the door seal comprises a sealing lip.

3. The door system according to claim 1, wherein the door leaf is connected via a door leaf connecting means, and the door seal via a door seal connecting means, with a rotary device associated with the door system.

4. The door system according to claim 3, wherein the door leaf connecting means and the door seal connecting means are configured in the shape of pivot arms, wherein, in each case, one first pivot arm end of the respective connecting means is connected to the rotary device, and wherein at least one guide means, in particular a guide roller, which is guided in a guiding profile respectively disposed on the door leaf and the door seal, is disposed in each case on a second pivot arm end of the respective connecting means opposite the first pivot arm end.

5. The door system according to claim 4, wherein the door seal connecting means has a first lever arm, and that the door leaf connecting means has a second lever arm, wherein the first lever arm is smaller than the second lever arm.

6. The door system according to claim 1, wherein the door leaf is connected via a door leaf connecting means, and the door seal via a door seal connecting means, in each case with separate rotary devices, wherein separate drive units are assigned to the respective rotary devices.

7. The door system according to claim 6, wherein a control unit, which is connected in a controlling manner with the rotary devices and is configured to recognize whether the door seal, during the opening of the door leaf, was moved across a predetermined door seal movement distance in the vehicle transverse direction, and is further configured, in the case of a movement of the door seal across the predetermined door seal movement distance in the vehicle transverse direction, to block further movement of the door seal during the opening of the door leaf.
